(19) United States
(12) Patent Application Publication
(10) Pub. No.: US 2025/0297656 A1
(43) Pub. Date: Sep. 25, 2025

(54) BRAKE MONITORING APPARATUS AND BRAKE APPARATUS

(71) Applicants: HYUNDAI MOTOR COMPANY, Seoul (KR); KIA CORPORATION, Seoul (KR)

(72) Inventor: Seung Hwan Yang, Jeonju-si (KR)

(73) Assignees: HYUNDAI MOTOR COMPANY, Seoul (KR); KIA CORPORATION, Seoul (KR)

(21) Appl. No.: 18/941,376

(22) Filed: Nov. 8, 2024

(30) Foreign Application Priority Data
Mar. 22, 2024 (KR) 10-2024-0039695

(51) Int. Cl. F16D 66/02; F16D 65/60; F16D 66/00; F16D 125/30

(52) U.S. Cl. CPC F16D 66/025; F16D 65/60; F16D 2066/005; F16D 2125/30

(57) ABSTRACT

A brake monitoring apparatus includes a controller configured to provide an on-signal after a parking state and a start-off state. The brake monitoring apparatus also includes a monitoring valve configured to allow compressed air to pass therethrough according to the on-signal. The brake monitoring apparatus also includes a brake apparatus configured to release the parking state according to the compressed air introduced from the monitoring valve. The brake apparatus includes a sensor unit configured to sense whether the parking state is normally released. The controller is further configured to provide an off-signal after providing the on-signal. The monitoring valve is further configured to discharge the compressed air introduced into the brake apparatus according to the off-signal.

### CROSS-REFERENCE TO RELATED APPLICATION

This application claims benefit of and priority to Korean Patent Application No. 10-2024-0039695 filed on Mar. 22, 2024 in the Korean Intellectual Property Office, the disclosure of which is incorporated herein by reference in its entirety.

### BACKGROUND

### 1. Field

The present disclosure relates to a brake monitoring apparatus and a brake apparatus.

### 2. Description of Related Art

A brake apparatus is an apparatus that reduces the speed of a vehicle, which is traveling or stops the vehicle, and may be the most important apparatus for vehicle safety. A brake apparatus of a vehicle may include an apparatus that converts rotational energy of tire wheels into heat energy by using friction to reduce the speed of the vehicle and stop the vehicle.

In addition, the brake apparatus may stably prevent the vehicle from moving by continuously providing braking force to wheels even in a parking state. However, when the parking state continues for too long, problems may occur in a process of releasing the parking state. The above problems may cause vehicle maintenance and/or towing, and the vehicle maintenance and/or towing may cause cost and time consumption and additional damage due to the unavailability to operate the vehicle. The subject matter described in this background section is intended to promote an understanding of the background of the disclosure and thus may include subject matter that is not already known to those of ordinary skill in the art.

### SUMMARY

An aspect of the present disclosure provides a brake monitoring apparatus that may monitor whether a parking state has been abnormally released. The present disclosure also provides a brake apparatus that may have a structure advantageous for monitoring whether the parking state has been abnormally released.

According to an aspect of the present disclosure, a brake monitoring apparatus includes a controller configured to provide an on-signal after a parking state and a start-off state. The brake monitoring apparatus also includes a monitoring valve configured to allow compressed air to pass therethrough according to the on-signal. The brake monitoring apparatus also includes a brake apparatus configured to release the parking state according to the compressed air introduced from the monitoring valve. The brake apparatus may include a sensor unit configured to sense whether the parking state has been normally released. The controller may provide an off-signal after providing the on-signal. The monitoring valve may discharge the compressed air introduced into the brake apparatus according to the off-signal.

According to another aspect of the present disclosure, a brake apparatus includes a brake input unit configured to provide force in a translation direction when compressed air is introduced or discharged. The brake apparatus also includes a force conversion unit configured to change a direction between the force in the translation direction and torque in a rotation direction. The brake apparatus also includes a brake body configured to provide a braking force according to a torque provided from the force conversion unit. The brake body is configured to provide torque according to release of the braking force to the force conversion unit. The brake apparatus also includes a sensor unit disposed in the force conversion unit and configured to sense the force in the translation direction of the brake input unit or the torque provided by the brake body.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view illustrating a brake apparatus and a partially enlarged structure according to an embodiment of the present disclosure;

FIG. 2A is a flowchart illustrating a process in which a brake apparatus enters a parking state according to an embodiment of the present disclosure;

FIG. 2B is a diagram illustrating a brake monitoring apparatus and a brake apparatus in a parking state according to an embodiment of the present disclosure;

FIG. 3A is a flowchart illustrating a monitoring operation of a brake monitoring apparatus and an operation of a brake apparatus according to the monitoring operation according to an embodiment of the present disclosure;

FIG. 3B is a diagram illustrating a brake monitoring apparatus and a brake apparatus when a parking state has been normally released;

FIG. 3C is a diagram illustrating a brake monitoring apparatus and a brake apparatus when a parking state has been abnormally released (or in a fixed state);

FIG. 4A is a flowchart illustrating a brake monitoring apparatus and a brake apparatus returning to a parking state after a monitoring operation according to an embodiment of the present disclosure;

FIG. 4B is a diagram illustrating a brake monitoring apparatus and a brake apparatus returning to a parking state after a monitoring operation according to an embodiment of the present disclosure; and

FIG. 5 is a flowchart illustrating method, performed by a controller of a brake monitoring apparatus, of determining whether a parking state has been normally released according to an embodiment of the present disclosure.

### DETAILED DESCRIPTION

The present disclosure may be subjected to various modifications and may have various embodiments. Thus, specific embodiments are illustrated in the drawings and described in detail in the detailed description. However, this is not intended to limit the present disclosure to a particular embodiment. Instead, it should be understood to include all changes, equivalents, and substitutes included in the spirit and art scope of the present disclosure.

Terms, such as first, second, etc., may be used to describe various components, but the components should not be limited by the terms. The terms are used only for the purpose of distinguishing one component from another. For example, a first component may be named as a second component, and similarly the second component may also be named as the first component without departing from the scope of the present disclosure. The term ‘and/or’ includes combinations of a plurality of associated listed items or any of a plurality of associated listed items.

The terms used herein are only used to describe specific embodiments and are not intended to limit the present disclosure. Singular expressions include plural expressions unless the context clearly means otherwise. It should be further understood that the terms “comprise” or “have” herein specify the presence of stated features, numbers, steps, operations, components, parts, or combinations thereof described in the present disclosure. However, the terms do not preclude the presence or addition of one or more other features, numbers, steps, operations, components, parts, or combinations thereof.

Unless otherwise defined, all terms (including technical or scientific terms) used herein may have the same meanings as commonly understood by those of ordinary skill in the art of the present disclosure. In addition, terms such as those defined in commonly used dictionaries should be interpreted as having a meaning consistent with the meaning in the context of the related technology. Unless explicitly defined here, the terms should not be interpreted as excessively ideal or formal sense.

Herein, vehicles (including electric vehicles) refer to various vehicles that move transported objects, such as people, animals, or goods, from a departure to a destination. These vehicles are not limited to vehicles that travel roads or tracks. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Hereinafter, embodiments of the present disclosure are described in more detail with reference to the attached drawings.

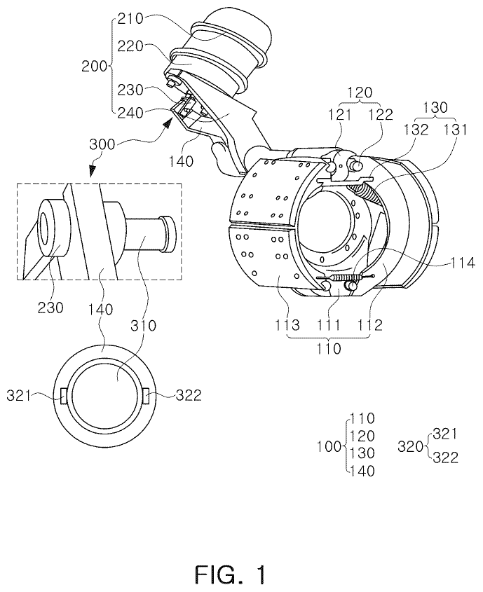

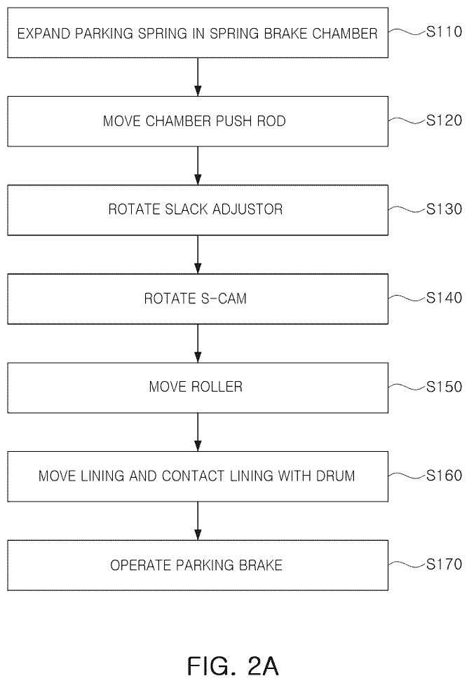

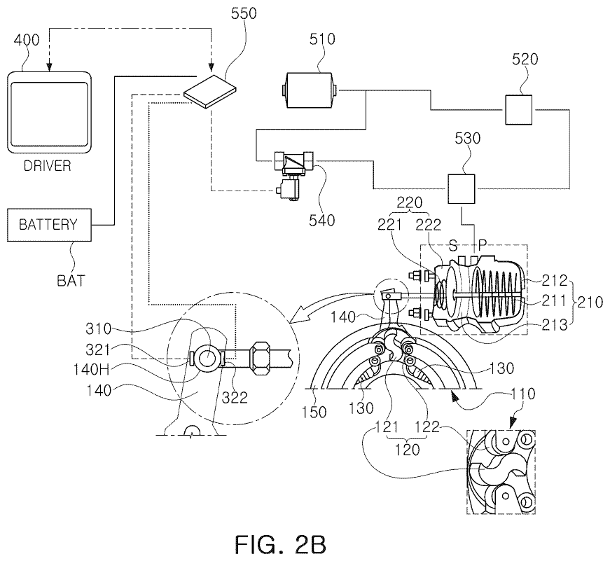

Referring to FIGS. 1 and 2B, a brake apparatus according to an embodiment of the present disclosure may include a brake body 100, a brake input unit 200, a force conversion unit 300, and a sensor unit 320.

The brake body 100 may be configured to provide a braking force according to torque provided from the force conversion unit 300 and provide torque according to release of the braking force to the force conversion unit 300. The brake body 100 may be coupled to a wheel of a vehicle. A part (e.g., a drum) of the brake body 100 may rotate according to the rotation of the wheel, and the remaining parts of the brake body 100 may not rotate according to the rotation of the wheel. When the brake body 100 provides the braking force, a part (e.g., a drum) of the brake body 100 may be fixed by forming a frictional force with respect to the remaining parts of the brake body 100. Accordingly, the rotation of the wheel of the vehicle may be suppressed.

For example, the brake body 100 may include at least one of a braking unit 110, a rotating unit 120, a return unit 130, a slack adjuster 140, or a drum 150. For example, the drum 150 may be installed on a wheel hub of a wheel through a bolt.

The braking unit 110 may include at least one of a back plate 111, a shoe 112, or a lining 113. The back plate 111 may be installed to be fixed to an axle of the vehicle and may be in a fixed form. The shoe 112 may be mounted on both sides of the back plate 111. One end of the shoe 112 may be connected to an anchor pin 114 of the back plate 111, and the other end of the shoe 112 may be connected to an S-cam 121 through a roller 122. Both sides of the shoe 112 may remain connected to the anchor pin 114 and the S-cam 121 by a return spring 131. The shoe 112 may rotate around the anchor pin 114 by moving the roller 122 along a cam profile when the S-cam 121 rotates. The lining 113 is a friction material and may be fixed to the shoe 112 through a rivet, etc. The lining 113 may contact the drum 150 or may be spaced apart from the drum 150 according to a movement of the shoe 112 as the S-cam 121 rotates.

The rotating unit 120 may include at least one of the S-cam 121 or two rollers 122. The S-cam 121 may be configured through holes in a chamber mounting bracket 240 and the back plate 111. Thus, the S-cam 121 is configured to be rotated by receiving torque from the force conversion unit 300 or to provide torque in a rotation direction by the return spring 131 to the force conversion unit 300 when braking is released. For example, the S-cam 121 may have a structure with an S-shaped head attached to one end of a cam shaft. The other end of the cam shaft may be connected to the slack adjuster 140.

The two rollers 122 may be configured to receive a force causing the two rollers 122 to move away from each other, and the force is generated by the rotation of the S-cam 121. The two rollers 122 may be configured to receive a force causing the two rollers 122 to move closer to each other so as to rotate the S-cam 121. The S-cam 121 may be disposed between the two rollers 122, and the distance to the roller from the center of the S-cam 121 thereof may be changed by a change in a rotation angle of the S-cam 121. As the distance from the center of the S-cam become longer, the S-cam 121 may further push the two rollers 122. As the distance from the center of the S-cam become shorter, the two rollers 122 may become closer to each other by return.

The two rollers 122 may be located in grooves or holes of parts on both sides of the shoe 112. A gap between the parts on both sides of the shoe 112 may become longer as the two rollers 122 move away from each other. A separation distance between the two rollers 122 may become shorter as the gap between the parts on both sides of the shoe 112 becomes shorter. The lining 113 may be disposed between the shoe 112 and the drum 150 and may contact the drum 150 when the two rollers 122 move away from each other as the S-cam 121 rotates. In response to a contact between the lining 113, which is a friction material, and the drum 150, the braking force of the brake body 100 may be formed.

The return unit 130 may include at least one of the return spring 131 or a spring bracket 132. Both ends of the spring bracket 132 may be connected to a plurality of points of the shoe 112, and the plurality of points may have little position change according to a movement of the shoe 112. One end of the return spring 131 may be connected to the spring bracket 132, and the other end of the return spring 131 may be connected to a point of the shoe 112. The one point may have a relatively large position change according to the movement of the shoe 112. Accordingly, the return spring 131 may extend as the shoe 112 expands and may provide a restoring force. When the restoring force is greater than the torque of the S-cam 121, the restoring force of the return spring 131 may reduce the gap between the parts on both sides of the shoe 112, and the two rollers 122 may be closer to each other.

When the drum 150 and the lining 113 remain in contact with each other for too long, a sticky force between the drum 150 and the lining 113 may be formed. The sticky force may be affected not only by a parking time of the vehicle but also by environmental conditions (e.g., moisture, temperature, etc.) or the lifespan of the brake body 100. Therefore, the sticky force may be a characteristic that is difficult to predict. When the sticky force is strong, the restoring force of the t return spring 131 may make it difficult to reduce the gap between the parts on both sides of the shoe 112. At this time, the two rollers 122 may not be closer to each other even though spaced apart from the S-cam 121.

The slack adjuster 140 may be connected to the end of an S-cam shaft and a pin of a push rod 230. The slack adjuster 140 may be rotated by the torque of the S-cam 121 and may also rotate by the force conversion unit 300.

When the sticky force between the drum 150 and the lining 113 is strong, the slack adjuster 140 may not receive an additional torque of the S-cam 121 due to the two rollers 122 during the restoration rotation of the S-cam 121. Accordingly, a position of the other end of the slack adjuster 140 may be affected by the sticky force between the drum 150 and the lining 113.

The brake input unit 200 may be configured to provide force in a translation direction as compressed air is introduced or discharged. For example, the brake input unit 200 may include at least one of a spring brake chamber 210, a service brake chamber 220, a push rod 230, or a chamber mounting bracket 240.

The spring brake chamber 210 may be coupled to the service brake chamber 220, may include a parking spring 211, and may include a chamber case 212 that accommodates the parking spring 211. When the vehicle is in a parking state, compressed air in the spring brake chamber 210 may be discharged from the spring brake chamber 210. Accordingly, the parking spring 211 may expand, and the spring brake chamber 210 may provide the force in the translation direction by pushing the push rod 230.

When the parking state of the vehicle is released, the compressed air may be introduced into an internal space 213 of the spring brake chamber 210 through a parking port P of the spring brake chamber 210. Accordingly, the parking spring 211 may be compressed, and a force with which the spring brake chamber 210 pushes the push rod 230 may be weakened. At this time, the service chamber 220 coupled to the spring brake chamber 210 may pull the push rod 230 and may provide the force in the translation direction.

The service brake chamber 220 may include a service spring 221 and a chamber case 222 that accommodates the service spring 221. When the vehicle is in a traveling state and a brake pedal of the vehicle operates, the compressed air may be introduced into the service brake chamber 220 through a service port S of the service brake chamber 220. Accordingly, the service spring 221 may be compressed, and the service brake chamber 220 may provide the force in the translation direction by pushing the push rod 230.

When the vehicle is in the traveling state and the brake pedal of the vehicle is restored, the compressed air may be discharged from the service brake chamber 220, the service spring 221 may expand, and a force with which the service brake chamber 220 pushes the push rod 230 may be weakened. At this time, the service brake chamber 220 may pull the push rod 230 and may provide the force in the translation direction.

One end of the chamber mounting bracket 240 may be connected to the service brake chamber 220, and the other end of the chamber mounting bracket 240 may be connected to the cam shaft of the S-cam 121. Accordingly, an arrangement relationship between the brake input unit 200 and the brake body 100 may be stabilized.

One end of the push rod 230 may be connected to the spring brake chamber 210 and the service brake chamber 220, and the other end of the push rod 230 may be connected to the force conversion unit 300. Accordingly, a position of the other end of the push rod 230 may be moved by the force in the translation direction of the push rod 230.

The force conversion unit 300 may couple the position of the other end of the push rod 230 to the position of the other end (through hole 140H) of the slack adjuster 140. The push rod 230 may be moved by the force in the translation direction, and the slack adjuster 140 may be rotated by the torque. Thus, the force conversion unit 300 may convert a direction between the force in the translation direction and the torque in the rotation direction.

The force conversion unit 300 may include a clevis pin 310 that is connected to the push rod 230 and penetrates the through hole 140H. The clevis pin 310 may fix a positional relationship between the position of the other end of the push rod 230 and the position of the other end (through hole 140H) of the slack adjuster 140. The clevis pin 310 may be coupled to a clevis, and the clevis may be connected to the push rod 230.

A diameter of the clevis pin 310 may be smaller than a diameter of the through hole 140H. Therefore, based on a relationship between the force in the translation direction of the brake input unit 200 linked to the clevis pin 310 and the torque of the brake body 100, a direction in which the clevis pin 310 pushes the slack adjuster 140 in the through hole 140H may vary. The relationship between the force in the translation direction and the torque in the rotation direction may be affected by the sticky force between the drum 150 and the lining 113.

The sensor unit 320 may be disposed in the force conversion unit 300 and may sense the force in the translation direction of the brake input unit 200 or the torque provided by the brake body 100. For example, the sensor unit 320 may be disposed to sense a pressure of the clevis pin 310 in the through hole 140H.

The sensor unit 320 may include an LS sensor 321 disposed on one side in the through hole 140H and an RS sensor 322 disposed on the other side in the through hole 140H. The LS sensor 321 may be disposed in the through hole 140H and may be configured to sense that the clevis pin 310 applies pressure to the slack adjuster 140 in a first direction. The RS sensor 322 may be disposed in the through hole 140H and may be configured to sense that the clevis pin 310 applies a pressure to the slack adjuster 140 in a second direction.

When the contact between the drum 150 and the lining 113 has been normally released, the S-cam 121 may receive a force from the two rollers 122 during the restoration rotation, and the S-cam 121 may provide torque based on the force of the two rollers 122 to the slack adjuster 140. Accordingly, the slack adjuster 140 may push the clevis pin 310, and the LS sensor 321 may sense the pressure. Accordingly, the LS sensor 321 may sense that the contact between the drum 150 and the lining 113 has been normally released.

When the drum 150 and the lining 113 are stuck therebetween, the S-cam 121 may be spaced apart from the two rollers 122 during the restoration rotation. The restoration rotation of the S-cam 121 may be implemented by the force with which the push rod 230 is pulled by the spring brake chamber 210. Thus, the clevis pin 310 may pull the slack adjuster 140 by the force with which the push rod 230 is pulled, and the RS sensor 322 may sense the pressure. Accordingly, the RS sensor 322 may sense the stuck condition between the drum 150 and the lining 113.

Referring to FIGS. 2A and 2B, the brake apparatus according to an embodiment of the present disclosure may perform a step (S110) in which the parking spring 211 in the spring brake chamber 210 expands, step (S120) in which the chamber push rod 230 moves, step (S130) in which the slack adjuster 140 rotates, step (S140) in which the S-cam 121 rotates, step (S150) in which the roller 122 moves, and step (S160) in which the lining 113 moves and contacts the drum 150, and step (S170) in which a parking brake operates.

Referring to FIG. 2B, the brake monitoring apparatus according to an embodiment of the present disclosure may include at least a part of the brake apparatus described above, may include a controller 550, a monitoring valve 540, and a sensor unit 320, and the sensor unit 320 may include at least one of the LS sensor 321 or the RS sensor 322.

The controller 550 may be configured to provide an on-signal after the parking state and a start-off state. For example, the controller 550 may be a part (e.g., a brake control apparatus) or at least one electronic control unit of vehicle and may be implemented as a microcomputer.

For example, the controller 550 may include a communication interface that performs communication (e.g., Controller Area Network; CAN communication) with a computing system 400 of the vehicle and may receive a vehicle start-on signal, a start-off signal, a parking lever operation signal, and a brake pedal signal from the vehicle computing system 400. The controller 550 may determine that the vehicle is in the start-off state by receiving the start-off signal and may determine that the vehicle is in the parking state by receiving the parking lever operation signal. For example, the computing system 400 may include a processor (e.g., CPU, GPU, or NPU) and a storage medium (e.g., volatile memory, non-volatile memory, data storage, etc.) input/output interface as well as the communication interface.

In addition, the controller 550 may receive the start-off signal and the parking lever operation signal and transmit an on-signal to the monitoring valve 540 after a first predetermined time has elapsed. For example, the controller 550 may include a clock and/or a timer and may count the first predetermined time by using the clock and/or the timer.

In addition, the controller 550 may transmit an off-signal to the monitoring valve 540 after a second predetermined time has elapsed since transmitting the on-signal to the monitoring valve 540 and may transmit the on-signal to the monitoring valve 540 after the first predetermined time or the third predetermined time has elapsed since transmitting the off-signal to the monitoring valve 540. In other words, the controller 550 may periodically provide each of the on-signal and the off-signal alternately multiple times. The number of periods between signals and a time length of each period are not particularly limited. For example, the controller 550 may count the first, second, and third predetermined times by using the clock and/or the timer.

The monitoring valve 540 may be configured to allow compressed air to pass therethrough according to the on-signal received from the controller 550. For example, the monitoring valve 540 may be implemented as a solenoid valve configured to receive a current signal corresponding to the on-signal from the controller 550 and switch whether the compressed air passes between a compressed air provider 510 and a double check valve 530 according to the current signal.

Referring to FIG. 2B, the brake monitoring apparatus according to an embodiment of the present disclosure may further include at least one of a battery BAT, the compressed air provider 510, a parking circuit 520, or the double check valve 530.

The battery BAT may supply power to the controller 550 at least after the start-off state. For example, the battery BAT may supply power to the controller 550 at all times. Accordingly, the controller 550 may operate stably even when the engine of the vehicle is turned off.

The compressed air provider 510 may be connected to the parking circuit 520 and may also be connected to the monitoring valve 540 through a circuit. For example, the compressed air provider 510 may be implemented as an air tank that accommodates compressed air.

The parking circuit 520 may be configured to allow compressed air introduced from the compressed air provider 510 to pass through when the vehicle is in the parking state. For example, the parking circuit 520 may include a parking valve that switches whether the compressed air passes according to the parking lever operation signal.

The double check valve 530 may be configured to have two inputs and one output. One of the two inputs is configured to receive the compressed air introduced from the monitoring valve 540 and the other one is configured to receive the compressed air introduced from the parking circuit 520. Output port is connected to the spring brake chamber 210. Of the two inputs, the compressed air in the one with the higher pressure is transferred to the output port. Therefore, the compressed air provided by the compressed air provider 510 may be introduced into the spring brake chamber 210 through the double check valve 530 in an on state in which each of the parking circuit 520 and the monitoring valve 540 may allow the compressed air to pass therethrough. In other words, the compressed air provided by the compressed air provider 510 may be introduced into the spring brake chamber 210 through the monitoring valve 540 and the double check valve 530 when the vehicle is in the parking state and the controller 550 provides an on signal. The parking state of the brake apparatus may be temporarily released.

At least one of the LS sensor 321 or the RS sensor 322 of the sensor unit 320 may be disposed in a part (e.g., the through hole 140H of the slack adjuster 140) of the brake apparatus to sense whether the parking state has been normally released. For example, when the parking state has been normally released, the LS sensor 321 disposed on the slack adjuster 140 may sense the pressure of the clevis pin 321. For example, when the parking state has been abnormally released (e.g., fixing between the drum 150 and the lining 113), the RS sensor 322 disposed on the slack adjuster 140 may sense the pressure of the clevis pin 321. The LS and RS sensors 321 and 322 may generate transmission signals when sensing the pressure and may transmit the transmission signals to the controller 550 wirelessly or by a wired method. For example, each of the LS and RS sensors 321 and 322 may be a pressure sensor that generates an electrical parameter (e.g., voltage, current, or resistance) corresponding to the pressure, and the electrical parameter may be directly transmitted to the controller 550 or converted into a communication signal and transmitted to the controller 550. For example, each of the LS and RS sensors 321 and 322 may include a circuit (e.g., a circuit for converting to a communication signal or a circuit for receiving power from the battery BAT), and the circuit may be embedded in the slack adjuster 140.

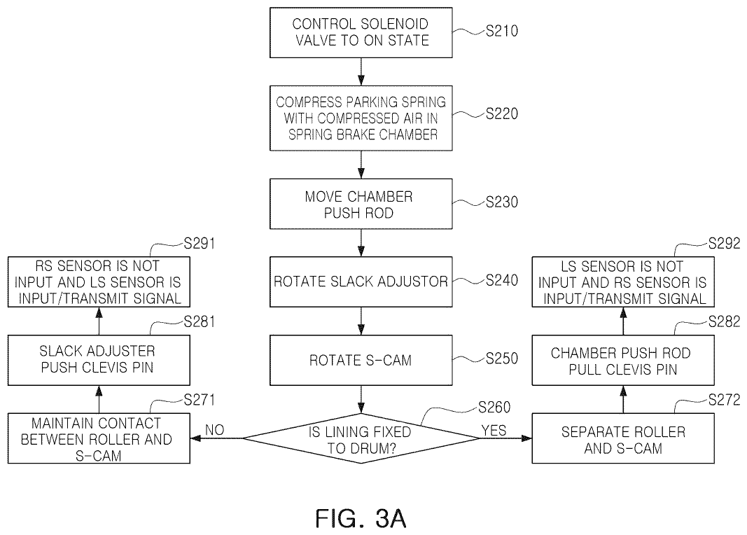

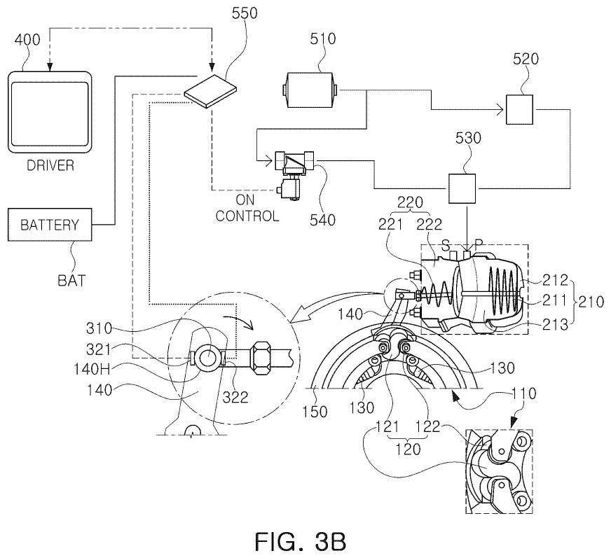

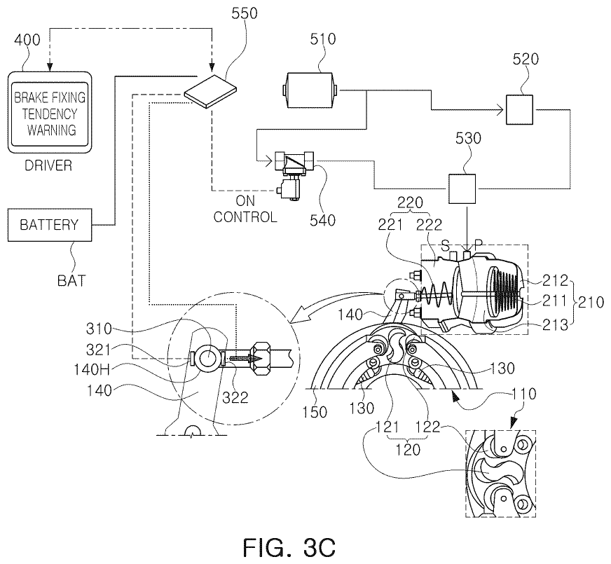

Referring to FIGS. 3A and 3B, the brake monitoring apparatus according to an embodiment of the present disclosure may perform a step (S210) of controlling the solenoid valve 540 to an ON state. Accordingly, through a step (S220) in which the compressed air 213 in the spring brake chamber 210 compresses the parking spring 211, a step (S230) in which the chamber push rod 230 moves (pulls), a step (240) in which the slacker adjuster 140 rotates (restores), and a step (250) in which the S-cam 121 rotates (restores), the parking state of the brake apparatus may be temporarily released.

At this time, the brake input unit (200 in FIG. 1) may be configured such that the force in the translation direction (pulling force), when the compressed air is introduced from the monitoring valve 540, is smaller than force at the force conversion unit 300 of the torque provided by the brake body 100 to the slack adjuster 140 according to a normal release of the braking force. For example, the force in the translation direction (pulling force) when the compressed air is introduced from the monitoring valve 540 may be adjusted by adjusting an opening width of the solenoid valve 540 and/or the double check valve 530 or adjusting the pressure of the compressed air provider 510. The size or shape of the spring brake chamber 210 of the brake input unit 200 may act as an adjustment variable in adjusting the opening width or adjusting the pressure.

Whether the lining 113 of the brake apparatus is stuck to the drum 150 (S260) may correspond to whether the parking state of the brake apparatus has been normally released. In a normal state in which the lining 113 is not stuck to the drum 150 (NO in S260), the contact between the roller 122 and the S-cam 121 may be maintained (S271), the slack adjuster 140 may push the clevis pin 300 (S281), the RS sensor 322 may not be input, and the LS sensor 321 may receive an input and may transmit a signal (S291). The LS sensor 321 may sense the torque provided by the brake body 100 according to a normal release of the braking force. The controller 550 may not generate a warning signal based on a sensing result of the LS sensor 321 and may generate information corresponding to a normal release of the parking state according to the sensing of the LS sensor 321.

Referring to FIGS. 3A and 3C, in an abnormal state in which the lining 113 is stuck to the drum 150 (YES in S260), the roller 122 and the S-cam 121 may be separated from each other (S272), the chamber push rod 230 may pull the clevis pin 300 (S282), the LS sensor 321 may not be input, the RS sensor 322 may receive an input and may transmit a signal (S292). The RS sensor 322 may sense the force in the translation direction when the compressed air is introduced from the monitoring valve 540. The controller 550 may generate a warning signal based on a sensing result of the RS sensor 322 and may generate information corresponding to an abnormal release of the parking state according to the sensing of the RS sensor 322, and the computing system 400 may output the warning signal. For example, the computing system 400 may output the warning signal by turning on a light emitting element of the vehicle or outputting sound of a speaker of the vehicle.

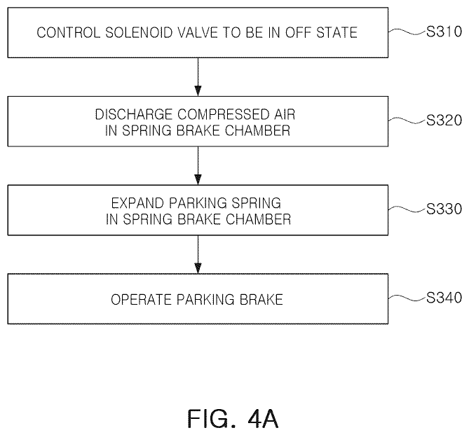

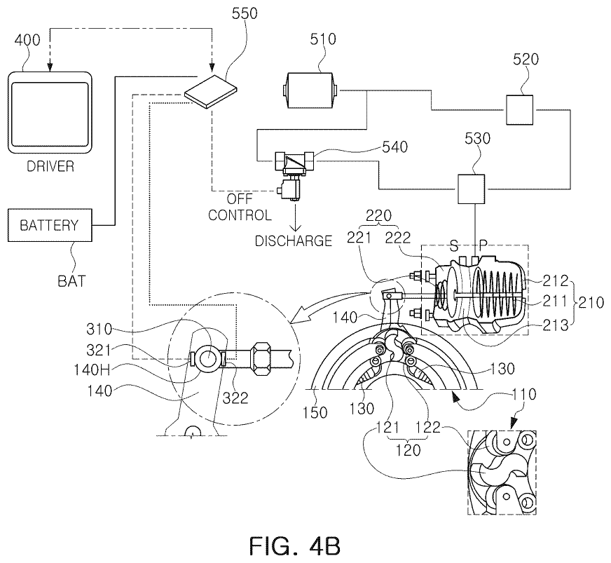

Referring to FIGS. 4A and 4B, after a sufficient time (e.g., a predetermined time) has passed from the controller 550 providing the on-signal until the LS and RS sensors 321 and 322 of the sensor unit 320 transmit the signal to the controller 550, the controller 550 may control the solenoid valve 540 to be in an OFF state (S310) by transmitting an off-signal to the monitoring valve 540. The monitoring valve 540 may discharge the compressed air introduced into the spring brake chamber 210 of the brake apparatus according to the off-signal (S320). In addition, the monitoring valve 540 may block compressed air from the compressed air provider 510 according to the off-signal. The parking spring 211 in the spring brake chamber 210 may expand (S330), and the parking brake may operate (S340).

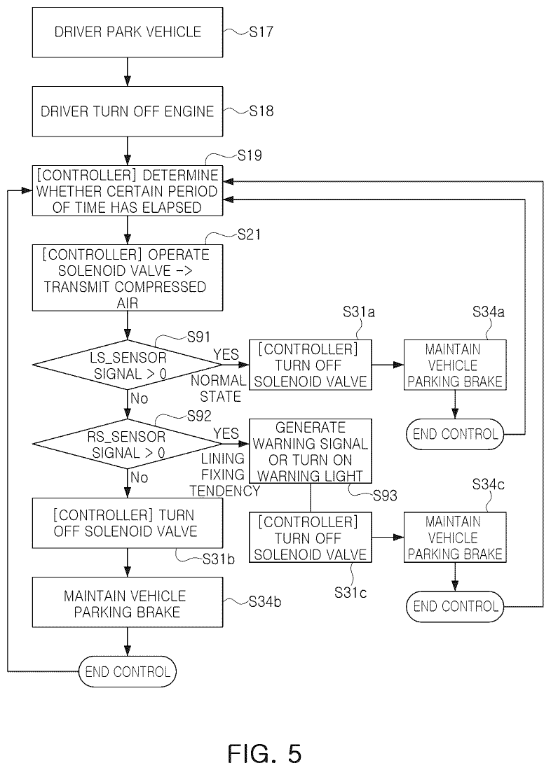

Referring to FIG. 5, a method, performed by a controller of a brake monitoring apparatus, of determining whether a parking state has been normally released according to an embodiment of the present disclosure may proceed after a vehicle driver parks a vehicle (S17) and turns off an engine (S18). According to the method, the controller may determine whether a certain period of time has elapsed after the vehicle was parked and the engine was turned off (S19), and when the certain period of time has elapsed, operate a solenoid valve (or a monitoring valve) (S21).

Thereafter, the controller may receive a signal from an LS sensor and determine whether a value (e.g., current or voltage) of the signal is greater than 0 (S91). When receiving the signal from the LS sensor (or when the value of the signal from the LS sensor is greater than 0) (YES in S91), the controller may turn off the solenoid valve (or the monitoring valve) (S31a) and maintain a vehicle parking brake (S34a).

When not receiving the signal from the LS sensor (or when the value of the signal from the LS sensor is less than or equal to 0) (NO in S91), the controller may receive a signal of an RS sensor and determine whether a value (e.g., current or voltage) of the signal is greater than 0 (S92). Here, when not receiving the signal from the RS sensor (or when the value of the signal from the RS sensor is less than or equal to 0) (NO in S92), the controller may turn off the solenoid valve (or the monitoring valve) (S31b) and maintain the vehicle parking brake (S34b).

When receiving the signal from the RS sensor (or when the value of the signal from the RS sensor is greater than 0) (YES in S92), the controller may control the vehicle to generate a warning signal or turn on a warning light (S93), turn off the solenoid valve (or the monitoring valve) (S31c), and maintain the vehicle parking brake (S34c).

The brake monitoring apparatus according to an embodiment of the present disclosure may monitor whether the parking state has been abnormally released, and the brake apparatus according to an embodiment of the present disclosure may have a structure advantageous for monitoring whether the parking state has been abnormally released.

While example embodiments have been shown and described above, it should be apparent to those having ordinary skill in the art that modifications and variations could be made without departing from the scope of the present disclosure as defined by the appended claims.

What is claimed is:

1. A brake monitoring apparatus comprising:
a controller configured to provide an on-signal after a parking state and a start-off state;
a monitoring valve configured to allow compressed air to pass therethrough according to the on-signal; and
a brake apparatus configured to release the parking state according to the compressed air introduced from the monitoring valve,
wherein the brake apparatus includes a sensor unit configured to sense whether the parking state is normally released,
wherein the controller is further configured to provide an off-signal after providing the on-signal, and
wherein the monitoring valve is further configured to discharge the compressed air introduced into the brake apparatus according to the off-signal.

2. The brake monitoring apparatus according to claim 1, further comprising:
a parking circuit configured to allow compressed air to pass therethrough in the parking state; and
a double check valve including:
two inputs, including a first input configured to receive the compressed air introduced from the monitoring valve and a second input configured to receive the compressed air introduced from the parking circuit; and
an output configured to deliver the compressed air of one of the two inputs into the brake apparatus.

3. The brake monitoring apparatus according to claim 1, wherein the controller is further configured to periodically provide each of the on-signal and the off-signal alternately multiple times.

4. The brake monitoring apparatus according to claim 1, further comprising: a battery configured to supply power to the controller at least after the start-off state.

5. The brake monitoring apparatus according to claim 1, wherein the controller is further configured to selectively generate a warning signal based on a sensing result of the sensor unit.

6. The brake monitoring apparatus according to claim 1, wherein the brake apparatus includes:
a brake input unit configured to provide force in a translation direction when compressed air is introduced or discharged;
a force conversion unit configured to change a direction between the force in the translation direction and torque in a rotation direction; and
a brake body configured to:
provide a braking force according to torque provided from the force conversion unit; and
provide torque according to release of the braking force to the force conversion unit,
wherein the sensor unit is disposed in the force conversion unit.

7. The brake monitoring apparatus according to claim 6, wherein the brake input unit is configured to provide the force in the translation direction in response to the compressed air introduced monitoring valve is smaller than force at the force conversion unit of the torque provided by the brake body according to a normal release of the braking force.

8. The brake monitoring apparatus according to claim 7, wherein the sensor unit includes:
an LS sensor configured to sense the torque provided by the brake body according to the normal release of the braking force; and
an RS sensor configured to sense the force in the translation direction when the compressed air is introduced from the monitoring valve, and
wherein the controller is further configured to:
generate information corresponding to a normal release of the parking state according to sensing of the LS sensor; and
generate information corresponding to an abnormal release of the parking state according to sensing of the RS sensor.

9. The brake monitoring apparatus according to claim 8, wherein
the brake input unit includes a push rod configured to be moved in the translation direction by the force in the translation direction,
the brake body includes a slack adjuster configured to be rotated by the torque, and the slack adjuster includes a through hole,
the force conversion unit includes a clevis pin configured to be connected to the push rod and penetrate the through hole,
the LS sensor is disposed in the through hole and configured to sense that the clevis pin applies a pressure to the slack adjuster in a first direction, and
the RS sensor is disposed in the through hole and configured to sense that the clevis pin applies a pressure to the slack adjuster in a second direction.

10. The brake monitoring apparatus according to claim 8, wherein the brake body includes:
a drum;
an S-cam disposed in the drum and configured to:
receive the torque provided from the force conversion unit so as to rotate; and
provide the torque by rotation to the force conversion unit;
two rollers configured to:
receive a force causing the two rollers to move away from each other, the force is generated by the rotation of the S-cam; and
receive a force causing the two rollers to move toward each other so as to rotate the S-cam;
a shoe configured to:
move toward the drum when the two rollers move away from each other; and
cause the two rollers to move toward each other when the shoe moves away from the drum; and
a lining disposed between the shoe and the drum and configured to contact the drum when the two rollers move away from each other,
wherein the LS sensor is configured to sense that a contact between the drum and the lining has been normally released, and
wherein the RS sensor is configured to sense sticking between the drum and the lining.

11. A brake apparatus comprising:
a brake input unit configured to provide force in a translation direction when compressed air is introduced or discharged;
a force conversion unit configured to change a direction between the force in the translation direction and torque in a rotation direction;
a brake body configured to:
provide a braking force according to torque provided from the force conversion unit; and
provide torque according to release of the braking force to the force conversion unit; and
a sensor unit disposed in the force conversion unit and configured to sense the force in the translation direction of the brake input unit or the torque provided by the brake body.

12. The brake apparatus according to claim 11, wherein the sensor unit includes:
an LS sensor configured to sense the torque provided by the brake body according to a normal release of the braking force; and
an RS sensor configured to sense the force in the translation direction of the brake input unit according to an abnormal release of the braking force of the brake body.

13. The brake apparatus according to claim 12, wherein
the brake input unit includes a push rod configured to be moved in the translation direction by the force in the translation direction,
the brake body includes a slack adjuster configured to be rotated by the torque, and the slack adjuster includes a through hole,
the force conversion unit includes a clevis pin configured to be connected to the push rod and penetrate the through hole,
the LS sensor is disposed in the through hole and configured to sense that the clevis pin applies a pressure to the slack adjuster in a first direction, and
the RS sensor is disposed within the through hole and configured to sense that the clevis pin applies a pressure to the slack adjuster in a second direction.

14. The brake apparatus according to claim 12, wherein the brake body includes:
a drum;
an S-cam configured to:
receive the torque from the force conversion unit so as to rotate; and
provide the torque by rotation to the force conversion unit;
two rollers configured to:
receive a force causing the two rollers to move away from each other, the force is generated by the rotation of the S-cam; and
receive a force causing the two rollers to move toward each other so as to rotate the S-cam;
a shoe configured to:
move toward the drum when the two rollers move away from each other; and
cause the two rollers to move toward each other when the shoe moves away from the drum; and
a lining disposed between the shoe and the drum and configured to contact the drum when the two rollers move away from each other,
wherein the LS sensor is configured to sense that a contact between the drum and the lining has been normally released, and
wherein the RS sensor is configured to sense sticking between the drum and the lining.

15. The brake apparatus according to claim 11,
wherein the brake input unit includes a push rod configured to be moved in the translation direction by the force in the translation direction,
the brake body includes a slack adjuster configured to be rotated by the torque, and the slack adjuster includes a through hole,
the force conversion unit includes a clevis pin configured to be connected to the push rod and penetrate the through hole, and
the sensor unit is disposed in the through hole and configured to sense a pressure of the clevis pin.

16. The brake apparatus according to claim 15, wherein the sensor unit includes:
an LS sensor disposed on a first side in the through hole; and
an RS sensor disposed on a second side in the through hole.
